(19) United States
(12) Patent Application Publication
(10) Pub. No.: US 2014/0153552 A1
(43) Pub. Date: Jun. 5, 2014

(54) COMMUNICATION METHOD, TRANSCEIVER STATIONS AND ASSOCIATED COMPUTER PROGRAMS

(71) Applicant: SCHNEIDER ELECTRIC INDUSTRIES SAS, Rueil-Malmaison (FR)

(72) Inventor: Philippe NUCCI, Sassenage (FR)

(73) Assignee: SCHNEIDER ELECTRIC INDUSTRIES SAS, Rueil-Malmaison (FR)

(21) Appl. No.: 14/088,953

(22) Filed: Nov. 25, 2013

(30) Foreign Application Priority Data
Dec. 3, 2012 (FR) 12 61558

(51) Int. Cl. H04W 52/02; H04L 5/00; H04W 24/10

(52) U.S. Cl. CPC H04W 52/0209; H04W 24/10; H04L 5/003
USPC 370/336; 370/329

(57) ABSTRACT

The invention relates to a method for communicating over a radiofrequency channel in a network including a primary node and multiple secondary nodes (10) for telecommunications.

The communication method comprises the following steps:
reception by a secondary node (10) on the radiofrequency channel of beacon messages (16) sent by nodes in its radio neighborhood, each indicating a number of radio hops separating the primary node from said node (10) of the radio neighborhood having sent the message;
selection by said secondary node (10), called child node, of the node from the wireless neighborhood having sent the beacon message (16) indicating a minimum number of hops as the parent node;
in order to send information (19) to the primary node, transmission of said information (19) over the radiofrequency channel to said parent node thus selected.

The present invention relates to the communication techniques used in telecommunications networks, particularly, but not exclusively, in ad hoc networks.

Ad hoc networks are telecommunications networks with no fixed infrastructure. A certain number of wireless stations equipped with wireless transmission and/or receiving means and suitable protocols form the nodes of an ad hoc network.

These stations can assume the form of fixed or portable computers, pocket computers, mobile telephones, vehicles, household appliances, etc. They can further be associated with modules such as sensors or actuators.

An ad hoc network of sensors thus makes it possible to collect information so as, for example, to watch or monitor installations.

In general, the nodes are powered by batteries that are difficult and expensive, or even impossible, to replace or recharge, or they are powered using a battery-free energy recovery technique. Energy savings are therefore a key factor in such networks.

Furthermore, a prefabricated wiring system installation is one example of an installation requiring temperature monitoring in many places so as to monitor its state.

Abnormal heating is frequently observed in the junction areas between two successive wiring system portions, due primarily to insufficient tightening of the bolts of the junction by the installer. The current solutions to these heating problems comprise preventive maintenance operations consisting of systematically tightening the bolts, and inspection operations to inspect the installations using thermal imaging cameras, making it possible to view areas undergoing abnormal heating.

However, these techniques have certain drawbacks: they are very long and complicated to carry out due to the large number of junctions to be checked and the positioning of the wiring system, which may be difficult to access: at a height, under the floor, under false ceilings, etc.

Furthermore, the reliability of the thermographic measurements depends on the measuring environment (presence of dust, grease, etc.), which makes the interpretation of the temperature state of the wiring systems relatively imprecise.

There is therefore a need to collect information from multiple points positioned along the electrical wiring systems regarding the temperatures noted at those multiple points.

According to a first aspect, the invention proposes a communication method, over a radiofrequency channel in a network including a primary node and multiple secondary nodes for telecommunications,

characterized in that it comprises the following steps:
reception by a secondary node on the radiofrequency channel of beacon messages sent by the nodes in its radio neighborhood, each indicating a number of radio hops separating the primary node from said node of the radio neighborhood having sent the message;
selection by said secondary node, called child node, of the node from the wireless neighborhood having sent the beacon message indicating a minimum number of hops as the parent node;
in order to send information to the primary node, transmission of said information over the radiofrequency channel to said parent node thus selected.

Such a method yields good performance in terms of transmission speed and energy consumption, particularly in the case of a linear network, typically a network in which the nodes are positioned at junctions of the wiring systems.

In one embodiment, the communication method comprises one or more of the following features:
in order to send information to the primary node, said information is emitted by said secondary node only to said parent node;
said secondary node periodically emits a beacon message on the radiofrequency channel indicating a number of radio hops separating it from the primary node equal to the number of radio hops separating the primary node from the parent node plus 1;
to emit said information on the radiofrequency channel to said parent node, the child node detects a beacon message periodically emitted by its parent node defining the beginning of a time window where it is able to receive information from the child node, the child node sending the information to the parent node during that window;
the child node periodically emits a beacon message defining the beginning of a time window where it can receive information from a node in its wireless neighborhood;
in order to detect the emission at a first given frequency of beacon messages by nodes in its wireless neighborhood, and a standard period with a length equal to an inverse period relative to the first frequency divided into several portions, at least one portion is listened to by said secondary node with at least one offset period relative to the listening to another portion, said secondary node being put on standby for at least part of the time separating the two listening operations for the two portions;
a new portion is listened to once said secondary node has a sufficient power level to listen to said portion;
the size of at least one portion depends on the power supply current level of said node;
the method is implemented to monitor the heat of wiring systems, such that the nodes are located at the wiring system junctions, and further comprise at least one temperature sensor, the information including data indicating at least temperatures measured by said sensors.

According to a second aspect, the invention proposes a transceiver station, to form a node capable of transmitting and receiving on a radiofrequency communication channel, the node belonging to a network including a primary node and multiple secondary nodes for telecommunications, said station comprising:
means for receiving respective beacon messages on the radiofrequency channel that are transmitted by nodes in its radio neighborhood, each indicating a number of radio hops separating the primary node from said node of the radio neighborhood that transmitted the message;
means for selecting, as the parent node of said node formed by the station, called child node, the node from the radio neighborhood having transmitted the beacon message indicating a minimum number of hops;
means for transmitting information to said parent node thus selected on the radiofrequency channel in order to send said information to the primary node.

In one embodiment, the transceiver station comprises one or more of the following features:
to send information to the primary node, it comprises means for transmitting said information, through said second node, exclusively to said parent node;
it comprises means for periodically transmitting a beacon message on the radiofrequency channel, indicating a number of radio hops separating it from the primary node equal to the number of radio hops separating the primary node from its parent node plus 1;
to transmit said information over the radiofrequency channel to said parent node, it comprises means for detecting a beacon message periodically transmitted by its parent node, defining the beginning of a time window where it is able to receive information from the station, the station sending the information to the parent node during that window;
it comprises means for sending a periodic beacon message defining the beginning of a time window where it is capable of receiving information from a node in its radio neighborhood;
in order to detect the transmission of beacon messages at a first given frequency by nodes in its radio neighborhood, and a standard period with a length equal to a period equal to the inverse of the first frequency being divided into several portion, it comprises means for listening to at least one portion by said secondary node with at least one offset period relative to the listening to another portion, said secondary node being put on standby at least for part of the time separating the listening to the two portions;
it comprises means for listening to a new portion as soon as it has a sufficient power level to listen to said portion;
the size of at least one portion depends on the power current level of the station;
the information sent by the parent node comprises an address for identifying the child node on the network;
it is suitable for thermal monitoring of wiring systems, is located at a wiring system junction, and further comprises at least one temperature sensor, the information including data indicating at least the temperatures measured by said sensors.

According to a third aspect, the invention proposes a computer program, to be installed in a transceiver station to form a node capable of transmitting over a radiofrequency channel, the node belonging to a network including a primary node and multiple secondary nodes for telecommunications, said program comprising instructions for carrying out the steps of a method according to the first aspect of the invention when the program is run by processing means of said transceiver station.

Other features and advantages of the invention will appear upon reading the following description. This description is provided purely as an illustration and must be read in light of the appended drawings, in which:

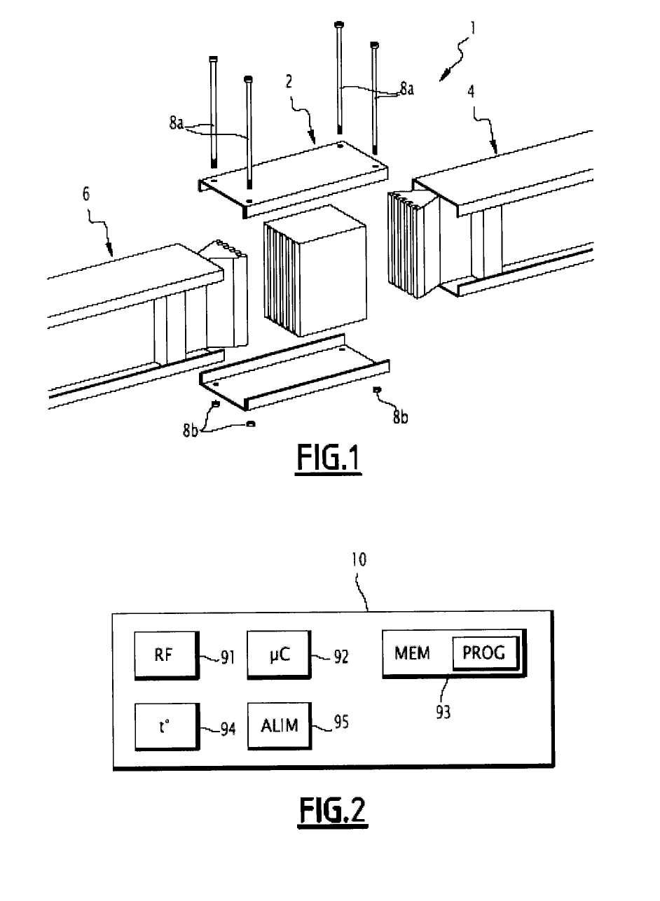

FIG. 1 is an exploded perspective view of part of a wiring system installation at an electrical junction;

FIG. 2 diagrammatically illustrates a transceiver station according to the invention;

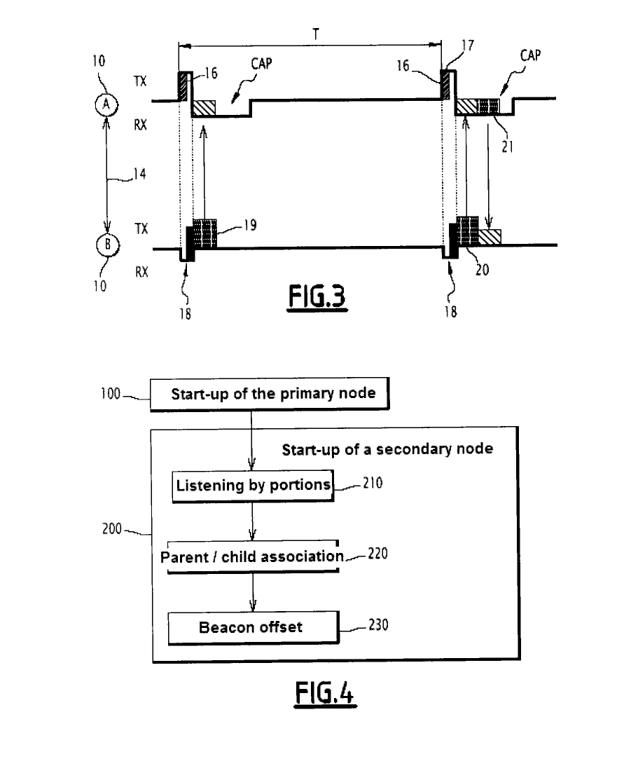

FIG. 3 is an explanatory diagram of the transmission of data between a parent node and a child node;

FIG. 4 is a flowchart of a communication method according to the invention;

FIG. 5 is an explanatory diagram of the transmission of data coming increasingly closer between nodes;

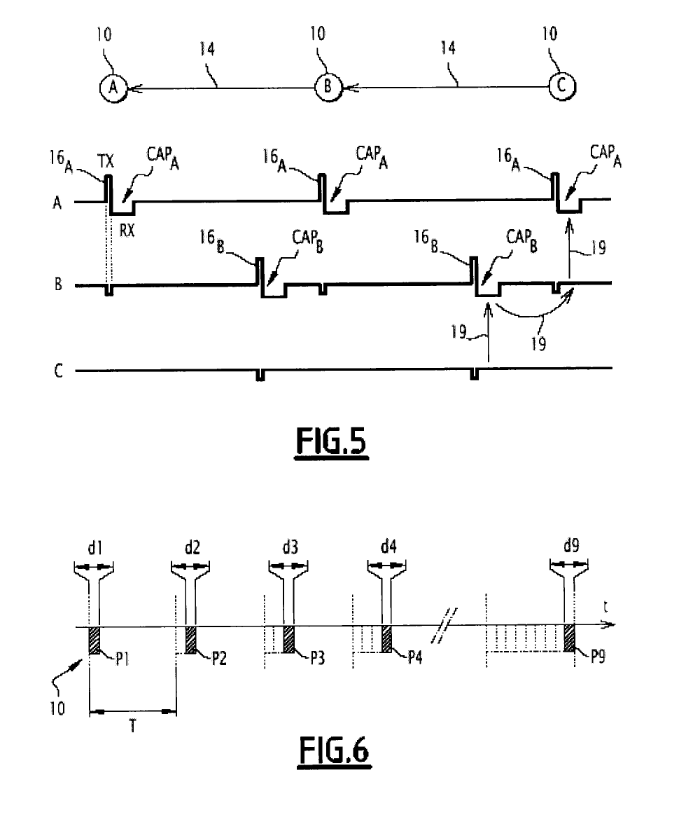

FIG. 6 is an explanatory diagram illustrating a beacon search operation for a secondary node;

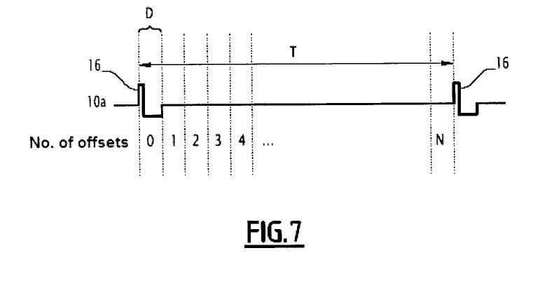

FIG. 7 illustrates the referential of the offsets relative to the primary node.

FIG. 1 shows, in one embodiment of the invention, a portion 1 of a wiring system installation at an electrical junction 2 using bolts 8a, 8b to connect a first wiring system segment 4 and a second wiring system segment 6.

During the installation of the wiring systems, the different segments, similar to the first 4 and second 6 segments, are inserted into junctions, similar to the junction 2. Next, bolts with separable heads, similar to the bolts 8a, 8b, are tightened using a dynamometric key in order to fasten the two segments to be connected, and current is passed from one segment to the other. Poor tightening at the junction 2 results in a deteriorated contact quality at one area of the junction which increases the current density and then causes abnormal heating at the junction 2.

The considered wiring system is for example 400 m long and for example comprises a junction every 4 m, or approximately one hundred junctions 2.

In one embodiment of the invention, each of these junctions 2 is provided with a station 10 associated with it, and which forms a telecommunications node of a telecommunications network according to the invention.

In the considered case, each station 10 associated with a junction is further adapted to monitor the thermal condition of the junction associated with it and to send information relative to that thermal condition to a particular station 10, or particular node, which collects all of the information from the stations of the wiring system. The information coming from the measurements of a given node includes an identifier of that node.

Said particular node 10 is called the primary node 10a. It may or may not also be associated with a junction. The other nodes of the network, which send information to the primary node 10a, are called secondary nodes 10b.

In reference to FIG. 2, each node, also called station, 10 comprises radiofrequency transceiver means 91, on a shared radiofrequency channel 14, for messages transmitted by, or to, nodes of its radio neighborhood.

A station 10 further includes a microcomputer 92, capable of executing software instructions, and a memory 93. A program PROG comprising software instructions is in particular stored in the memory 93.

A station 10 further includes a power supply module 95, suitable for powering the different elements of the station 10.

This power supply module 95, in the case of secondary nodes 10b, is for example suitable for converting the received vibrational and/or thermal energy into electricity.

The power supply module 95 for the primary node 10a includes, or is connected to, a power source that provides it with electricity at all times, for example the electrical grid.

In the case of a secondary node 10b and, if applicable, the primary node 10a, the station 10 further includes a heat sensor 94 capable of measuring the local temperature of the associated junction regularly.

In one embodiment, the station 10 is further suitable for processing temperature measurements done by the thermal sensor 94, and based on a comparison of those processed measurements and a threshold, for example, generating an alert, inserted, with the identifier of the station 10, into the information to be sent to the primary node 10a.

Each node 10 is capable of communicating directly with another node 10 of its radio neighborhood using a communication method according to the invention, based on a 802.15.4 communication protocol defined by the Institute of Electrical and Electronics Engineers, called IEEE, and applicable to wireless networks, the communication being done over the shared radiofrequency channel 14, at a given frequency.

The frequency chosen for the communication is for example comprised between 2400 MHz and 2483.5 MHz and is, in the considered equivalent case, in the radio spectrum of 2.4 GHz ISM (Industrial Scientific Medical, License Free).

The method according to the invention is in particular based on the PHY and MAC layers of protocol 802.15.4, and implements transmission and reception operations that are synchronized between the nodes 10 using beacons 16 transmitted at each period T by the nodes 10.

All of the steps described below are carried out by the nodes 10 following the execution of software instructions by the computer program PROG on the microcomputers 92 of the nodes.

In reference to FIG. 3, the sending of information between a parent node 10, referenced A, and a child node 10, referenced B, the definition of the terms parent and child being provided below, is done using an uplink communication, i.e., from the child node B to the parent node A, and a downlink communication, i.e., from the parent node A to the child node B.

A child node B is suitable for listening to the radiofrequency channel 14 at the predetermined moment of the transmission of a beacon signal 16 by the parent node A and to detect the transmission of that beacon 16 (which corresponds to the “beacon tracking” operation of protocol 802.15.4).

This beacon 16 transmitted by the parent node A is a start-up signal for a child node B of the node A, so that it sends information to the node A. It includes several data fields, in particular a network identifier PANId, an identifier of the node A having transmitted beacon, and other information described below.

In fact, the node B transmits information 19 to its parent node A after the transmission of the beacon 16 by the node A, in a time window called CAP (Contention Access Period). In order to avoid any collisions between messages, before transmitting, it verifies that the channel 14 is not occupied, by listening 18 according to the CSMA/CA (Carrier Sense Multiple Access with Collision Avoidance) access method defined by the IEEE.

The parent node A listens to the messages that may be sent to it by each of its child nodes B in the CAP that follows the transmission of the beacon 16 transmitted by the node A.

Protocol 802.15.4 further provides a mechanism that allows a parent node A not only to receive messages from a child node B, but also to send them to it.

Thus, when the parent node A must send information to a child node B, the node A indicates in the beacon 16 that it will transmit information 21 available for the child node B (cf. indication 17 in FIG. 3). The information then remains stored in the node A. The concerned child node B then transmits a command 20 in the CAP following the transmission of the beacon 16, which causes the node A to transmit information 21, the node B readying itself to receive that information 21 following the sending of its command 20.

This communication is described as indirect, since the message 21 contained in the node A is not directly sent to the node B. Such a downlink communication mode, although offering lower throughputs due to this indirect communication is well-suited to the considered case, since the downlink data stream is much smaller than the uplink data stream.

The flowchart of FIG. 4 shows steps 100, 200, 210, 220, 230 of a communication method in one embodiment of the invention.

During a step 100 for starting up the primary node 10a, the latter ensures that no other network transmitting with a same identifier PANId exists on the channel 14 assigned to the network of the primary node 10a, to which an identifier PANId characterizing that network has been assigned.

To that end, the primary node 10a performs passive listening so as to verify that it does not receive any beacon 16 comprising an identifier.

The primary node 10a then transmits beacons 16 separated by a period T, in which it is identified as the primary node or “PAN coordinator”, in accordance with protocol 802.15.4.

When it is started up 200, any secondary node 10b carries out a certain number of steps 210, 220, 230:
a prior listening step 210 aiming to scan the channel 14 for a length of time equivalent to a complete period T, and to detect the beacons 16 transmitted on the channel 14 and thus determine the nodes present in its radio neighborhood;
then, in step 220, the secondary node 10b determines a single parent node to which it will send information 19 intended for the primary node 10a;
then, during a step 230, the secondary node 10b determines an offset to be performed between its own beacon signal and the beacon signal from its parent, then it in turn transmits a beacon 16 at each period T.
Once the startup steps have been performed, the secondary node 10b can function operationally as for example described in reference to FIG. 3.

These various steps are outlined below.

Only a certain number of secondary nodes 10b can communicate directly with the primary node 10a: these are secondary nodes 10b that are situated within radio range of the primary node 10a.

The rank of a node 10 is defined as the number of radio hops separating that node 10 from the primary node 10a.

Thus, the primary node 10a has rank zero. The secondary nodes 10b that receive the beacons 16 from the primary node 10a when they carry out a step 210 are ranked 1.

The secondary nodes 10b that receive, during step 210 which they perform upon start-up, the beacons 16 of rank 1 without receiving the beacons 16 from the primary node 10a, are ranked 2, etc.

Thus the transfer of information 19 from a secondary node 10b, with a rank strictly greater than 1 to the primary node 10a go through intermediate nodes 10b with a rank decreasing by 1 each time.

According to the invention, each node 10 includes its rank in the beacon signals 16 that it transmits.

Thus, when the node 10b listens 210 to the channel 14 equivalent to a period T, it receives the beacons 16 from all of the nodes 10 transmitting in its network neighborhood, each of these beacons 16 indicating the rank of the node 10 that emitted it.

In step 220, the secondary node 10b then select, as parent node, among those nodes 10 in its radio neighborhood, that which emitted the beacon 16 indicating a minimum rank. The rank that the node 10b next transmits its own beacons 16 will be equal to the rank of its parent, plus one.

In one embodiment, the choice of the parent from among several nodes 10 by the given node depends on the rank of said nodes 10 and/or indicators of the quality of the communication between the given node and each of the nodes 10, indicating the offset between its beacon signal and the beacon signal emitted by its own parent (a parent having the lowest beacon offset relative to that of its parent will for example be chosen as a priority, leading to a quicker collection of information by the primary node).

Once the secondary node 10b has chosen its parent node, it enters a beacon monitoring mode. This mode consists of putting itself in standby, only to wake up at the predetermined time of the transmission of the beacons 16 from its parent node so as to exchange data with the parent node in the CAP window of the parent node, or to wake up only upon transmission of its own beacons 16 so as to exchange data, during its own window CAP, with its child node(s).

FIG. 5 illustrates the transfer of data from a node C (rank K+1), to its parent node (rank K), and from there to the parent node A (rank K−1) of the node B, this data thus being relayed from child to parent up to the primary node 10a.

The node B transmits beacons 16_{B} making it possible to calibrate its exchanges with its child node(s), including the node C. The node C examines the transmission of the beacons 16_{B} by its parent node B, so as to send information to be sent 19 during the window CAP_{B} following those beacons 16_{B}.

In one embodiment, the scanning step 210 upon start-up of a secondary node 10b is done in such a way as to save the available energy by performing listening equivalent to one period T per portion.

In reference to FIG. 6, the node 10b listens, beginning at time t0, to the channel 14 so as to detect all of the beacons 16 transmitted by the nodes within radio range not over a complete period T, but it listens for several periods T of the portions P1 to Pn, which modulo T, make it possible to go over the equivalent of a complete period. Each portion Pi lasts a time dᵢ. The duration di is strictly shorter than T. Between two consecutive listening portions, the node 10b enters standby mode so that the power supply module 95 recharges.

During the first period T beginning as of t0, the node 10b listens to the channel 14 for a portion P₁, from t0 to t0+d₁, to detect the transmitted beacons. It then enters standby mode to awaken during the second period beginning as of t0 only at t0+T+d₁ and to listen to the channel 14 for a portion P₂, from t0+T+d₁ to t0+T+d₁+d₂, before returning to standby mode.

Thus, for i=1 at n, these steps are reiterated: the node 10b enters standby mode following listening to the portion Pᵢ₋₁, and awakens during the i^{th} period as of t0 only at t0+T+d₁ . . . +dᵢ₋₁, and to listen to the channel 14 during the portion Pᵢ, from t0+T+d₁ . . . +dᵢ₋₁ two t0+T+d₁ . . . +dᵢ₋₁+dᵢ, before returning to standby mode.

In the case illustrated in FIG. 6, n=9, dᵢ=d constant for i=1 to 9.

In practice, the listening duration is greatly extended: with listening portions of 15 ms, it takes 17 min. to completely listen to a period between two beacons 16, the transmission of which is separated by 4 s.

Alternatively, the portion to be listened to is defined by implementing a scanning algorithm by dichotomy.

Alternatively, the listening is not done with one listened portion per period T, but the node 10b listens to a new portion Pᵢ as soon as it has accumulated enough power to listen to such a portion P with duration dᵢ. In this alternative, the overall listening is faster, but managing storage of the portions already listened to, or to be listened to, is more complex.

Also alternatively, the listening duration dᵢ is variable and for example depends on the power available in the node 10b performing the listening. In this alternative, the overall listening is faster.

Each node is identified by a single 64-bit address, called extended address.

In order to limit the volume of data exchanged, in particular due to the insertion of the identifier of a node into the beacons that it transmits or into the data collected by the primary node representative of the temperature measurements done by the node, the nodes integrated into the network are identified by a shorter address, specific to the network and assigned the primary node 10a. Once a node has chosen a parent, it sends a request for the assignment of a short address relayed to the primary node 10a, which will then send it that short address in return.

The secondary node 10b can then in turn transmit beacons 16 and data, using that short address.

In one embodiment of the invention, the transmission moment of the beacons 16 by the considered secondary node 10b is chosen in a step 230, complying with certain rules, alternatingly or in combination which are described below.

A node 10b cannot transmit a beacon at the same time as its parent, as at that time it must be listening to the transmissions from its parent. Therefore, the offset δ between the transmission by the parent node of its beacon and the transmission by the secondary node 10b must be strictly shorter than T and strictly greater than zero.

The secondary node 10b therefore excludes the offset corresponding to its own parent from the list of potential offsets from which it selects its own offset.

The secondary node 10b also cannot transmit any beacons 16 when nodes 10 that are listening and within radio range, in the process of monitoring a beacon transmission 16 from another node, since the transmission of a beacon 16 is done without prior CSMA/CA, and the received signal would then be a mixture of two beacons 16 (the radio range is considered to be the same for transmission and reception).

To avoid this type of conflict, each node 10 further indicates, in its beacon 16, the offset relative to its own beacon, from the beacon transmitted by its parent. Thus, once a node 10 has performed its initial listening for beacons 16 in step 210, it knows, for all of the nodes 10 that are within its range, the list of those offsets to avoid. The secondary node 10b therefore excludes, from the list of potential offsets, those corresponding to the parents of the nodes located in its radio range.

Once the offsets δ already used by immediate neighbors and of the second order are excluded (a consequence is that information transmitted by a child node in the CAP of its parent are only received by the parent), many possible free offsets δ may remain, and choosing those offsets δ wisely makes it possible to escalate the data to the primary node 10a as quickly as possible.

In order to avoid disrupting the nodes seeking to join the network and that are within radio range of two nodes transmitting their beacon at the same time, the offsets corresponding to the transmission moments of the beacons of the nodes within radio range of the considered secondary node are excluded from the list of potential offsets.

To avoid pointless consumption (reception of a pointless beacon signal) and loss of bandwidth (reduction of moments in a window CAP where the other nodes may transmit), the offset must be such that the beacon transmitted by the considered secondary node is outside the CAP windows of the nodes within its radio range.

The length of the offset is chosen to be equal to a whole factor of the duration D equal to the sum of the transmission duration of the beacon and the duration of a CAP window, and the unit chosen to measure it has that duration D as its unit.

In reference to FIG. 7, each of the offsets is thus numbered between 0 (which corresponds to the transmission moment by the primary node 10a of its beacon 16) and N, equal to the whole value of the quotient of T divided by D. The numbers indicated in FIG. 7 correspond to the absolute reference (i.e., having for origin the offset of the primary node 10a).

In the beacons, the offsets may be according to the embodiments indicated in absolute value. An offset of the parent of a node indicated in the beacon of the node may, in one embodiment, be indicated in a reference relative to the node (i.e., having the offset of said node as its origin).

Once the aforementioned indicated offsets are excluded, many free possible offset values may remain. The considered secondary node 10b chooses, among them, the largest possible offset that is below the beacon offset of its parent.

If no offset meeting these two conditions is available, it chooses the greatest possible offset that is greater than the beacon offset of its parent.

This choice of the value of the offset allows a faster collection of information by the primary node 10a.

Applying the invention to the case described above therefore makes it possible to collect information allowing the location of thermal defects on an electrical installation while minimizing the energy used by each of the telecommunications nodes 10 and optimizing the information collection speed by a primary node 10a.

Of course, the invention may be used for data communication purposes other than for data relative to temperature, and in contexts other than wiring systems.

1. A communication method, over a radiofrequency channel in a network including a primary node and multiple secondary nodes for telecommunications, comprising the following steps:
reception by a secondary node on the radiofrequency channel of beacon messages sent by the nodes in its radio neighborhood, each indicating a number of radio hops separating the primary node from said node of the radio neighborhood having sent the message;
selection by said secondary node, called child node, of the node from the wireless neighborhood having sent the beacon message indicating a minimum number of hops as the parent node;
in order to send information to the primary node, transmission of said information (over the radiofrequency channel to said parent node thus selected.

2. The communication method according to claim 1, wherein, in order to send information to the primary node, said information is emitted by said secondary node only to said parent node.

3. The communication method according to claim 1, wherein said secondary node periodically emits a beacon message on the radiofrequency channel indicating a number of radio hops separating it from the primary node equal to the number of radio hops separating the primary node from the parent node plus 1.

4. The communication method according to claim 1, wherein, to emit said information on the radiofrequency channel to said parent node, the child node detects a beacon message periodically emitted by its parent node defining the beginning of a time window where it is able to receive information from the child node, the child node sending the information to the parent node during that window.

5. The communication method according to claim 1, wherein the child node periodically emits a beacon message defining the beginning of a time window where it can receive information from a node in its wireless neighborhood.

6. The communication method according to claim 1, wherein in order to detect the emission at a first given frequency of beacon messages by nodes in its wireless neighborhood, and a standard period with a length equal to an inverse period relative to the first frequency being divided into several portions, at least one portion is listened to by said secondary node with at least one offset period relative to the listening to another portion, said secondary node being put on standby for at least part of the time separating the two listening operations for the two portions

7. The communication method according to claim 6, wherein a new portion is listened to as soon as said secondary node has a sufficient power level to listen to said portion.

8. The communication method according to claim 6, wherein the size of at least one portion depends on the power supply current level of said node.

9. The communication method according to claim 1, implemented to monitor the heat of wiring systems, wherein the nodes are located at the wiring system junctions, and further comprise at least one temperature sensor, the information including data indicating at least temperatures measured by said sensors.

10. A transceiver station, to form a node capable of transmitting and receiving on a radiofrequency communication channel, the node belonging to a network including a primary node and multiple secondary nodes for telecommunications, said station comprising:
means for receiving respective beacon messages on the radiofrequency channel that are transmitted by nodes in its radio neighborhood, each indicating a number of radio hops separating the primary node from said node of the radio neighborhood that transmitted the message;
means for selecting, as the parent node of said node formed by the station, called child node, the node from the radio neighborhood having transmitted the beacon message indicating a minimum number of hops;
means for transmitting information to said parent node thus selected on the radiofrequency channel in order to send said information to the primary node thus selected.

11. The transceiver station according to claim 10, wherein to send information to the primary node, it comprises means for transmitting said information, through said second node, exclusively to said parent node.

12. The transceiver station according to claim 10, comprising means for periodically transmitting a beacon message on the radiofrequency channel, indicating a number of radio hops separating it from the primary node equal to the number of radio hops separating the primary node from its parent node plus 1.

13. The transceiver station according to claim 10, wherein to transmit said information over the radiofrequency channel to said parent node, it comprises means for detecting a beacon message periodically transmitted by its parent node, defining the beginning of a time window where it is able to receive information from the station, the station sending the information to the parent node during that window.

14. The transceiver station according to claim 10, comprising means for sending a periodic beacon message defining the beginning of a time window where it is capable of receiving information from a node in its radio neighborhood.

15. The transceiver station according to claim 10, wherein in order to detect the transmission of beacon messages at a first given frequency by nodes in its radio neighborhood, and a standard period with a length equal to a period equal to the inverse of the first frequency being divided into several portions, it comprises means for listening to at least one portion by said secondary node with at least one offset period relative to the listening to another portion, said secondary node being put on standby at least for part of the time separating the listening to the two portions.

16. The transceiver station according to claim 15, comprising means for listening to a new portion as soon as it has a sufficient power level to listen to said portion.

17. The transceiver station according to claim 15, wherein the size of at least one portion depends on the power current level of the station.

18. The transceiver station according to claim 10, wherein the information sent by the parent node comprises an address for identifying the child node on the network.

19. The transceiver station according to claim 10, wherein it is suitable for thermal monitoring of wiring systems, is located at a wiring system junction, and further comprises at least one temperature sensor, the information (including data indicating at least the temperatures measured by said sensors.

20. A computer program, to be installed in a transceiver station to form a node capable of transmitting over a radiofrequency channel, the node belonging to a network including a primary node and multiple secondary nodes for telecommunications, said program comprising instructions for carrying out the steps of a method according to claim 1 when the program is run by processing means of said transceiver station.
